(19) United States
(12) Patent Application Publication
(10) Pub. No.: US 2024/0381506 A1
(43) Pub. Date: Nov. 14, 2024

(54) LOAD CONTROL DEVICE FOR A LIGHT-EMITTING DIODE LIGHT SOURCE

(71) Applicant: Lutron Technology Company LLC, Coopersburg, PA (US)

(72) Inventors: Robert C. Newman, JR., Emmaus, PA (US); Stuart W. DeJonge, Riegelsville, PA (US)

(73) Assignee: Lutron Technology Company LLC, Coopersburg, PA (US)

(21) Appl. No.: 18/781,054

(22) Filed: Jul. 23, 2024

Related U.S. Application Data
(63) Continuation of application No. 17/083,262, filed on Oct. 28, 2020, now Pat. No. 12,082,322.
Application No. 17/083,262 is a continuation of application No. 16/532,365, filed on Aug. 5, 2019, now Pat. No. 10,827,586.
Application No. 16/532,365 is a continuation of application No. 15/496,932, filed on Apr. 25, 2017, now Pat. No. 10,397,991.
(60) Provisional application No. 62/327,198, filed on Apr. 25, 2016.

(51) Int. Cl. H05B 45/44; H02M 1/10; H05B 45/10; H05B 45/38; H05B 45/382; H05B 45/39; H05B 47/155; H05B 47/165

(52) U.S. Cl. CPC H05B 45/44; H02M 1/10; H05B 45/38; H05B 45/382; H05B 45/10; H05B 45/39; H05B 47/155; H05B 47/165; Y02B 20/30

(57) ABSTRACT

A load control device for controlling power delivered from a power source to an electrical load may comprise a control circuit configured to control the load regulation circuit to control the power delivered to the electrical load. The control circuit may be configured to operate in an AC mode when an input voltage is an AC voltage and in a DC mode when the input voltage is a DC voltage. The control circuit may be configured to disable the power converter in the DC mode. The control circuit may be configured to render a controllable switching circuit conductive in the AC mode, and non-conductive in the DC mode. The rectifier circuit may be configured to rectify the input voltage to generate a rectified voltage when the input voltage is an AC voltage, and to pass through the input voltage when the input voltage is a DC voltage.

### CROSS-REFERENCE TO RELATED APPLICATIONS

This application is a continuation of U.S. patent application Ser. No. 17/083,262, filed Oct. 28, 2020; which is a continuation of U.S. patent application Ser. No. 16/532,365, filed Aug. 5, 2019 (now U.S. Pat. No. 10,827,586), which is a continuation of U.S. patent application Ser. No. 15/496,932, filed Apr. 25, 2017 (now U.S. Pat. No. 10,397,991), which claims the benefit of U.S. Provisional Application No. 62/327,198, filed Apr. 25, 2016, the disclosures of which are incorporated by reference herein in their entireties.

### BACKGROUND

Light-emitting diode (LED) light sources (such as, for example, LED light engines) are often used in place of or as replacements for conventional incandescent, fluorescent, or halogen lamps, and the like. LED light sources may comprise a plurality of light-emitting diodes mounted on a single structure in a suitable housing. LED light sources are typically more efficient and provide longer operational service as compared to incandescent, fluorescent, and halogen lamps. In order to illuminate properly, an LED driver is typically coupled between an alternating-current (AC) source and the LED light source for regulating the power supplied to the LED light source. The LED driver may regulate either the voltage provided to the LED light source to a particular value, the current supplied to the LED light source to a specific peak current value, or both the current and the voltage. Examples of LED drivers are described in greater detail in commonly-assigned U.S. Pat. No. 8,492,987, issued Jul. 23, 2010, and U.S. Pat. No. 8,680,787, issued Mar. 25, 2014, both entitled LOAD CONTROL DEVICE FOR A LIGHT-EMITTING DIODE LIGHT SOURCE, the entire disclosures of which are hereby incorporated by reference.

As the electrical infrastructure changes to accommodate renewable energy sources (e.g., wind power, photovoltaic solar power, full cells, etc.), it is likely that there will be a movement towards DC power distribution as this is the native version of generation for many of these technologies. For example, photovoltaic solar arrays generate DC power and often this is directly stored in batteries. From there, power may be provided directly from the batteries, or it may be inverted to alternating current for use by appliances. With this anticipated move to a DC power bank, it would be desirable to provide power directly as DC power rather than convert it to AC power. Many AC electrical loads actually use DC power to perform their functions, and traditionally require rectification, and often, active power factor correction (PFC), to make the AC power useful to the electrical load. However, the rectification and active power factor correction operations introduce an efficiency loss.

### SUMMARY

As described herein, a load control device for controlling power delivered from a power source to an electrical load may comprise a power converter configured to generate a bus voltage across a bus capacitor; a load regulation circuit configured to receive the bus voltage and to control the power delivered to the electrical load; and a control circuit configured to control the load regulation circuit to control the power delivered to the electrical load. The control circuit may be configured to operate in an AC mode when an input voltage is an AC voltage, and in a DC mode when the input voltage is a DC voltage. The control circuit may be configured to disable the power converter in the DC mode, for example, when the power required by the load is less than a threshold amount. In addition, the control circuit may be configured to control the power converter circuit to adjust the magnitude of the bus voltage towards a target bus voltage, and adjust the target bus voltage as a function of the power required by the load, when the power required by the load is greater than the threshold amount in the DC mode. Additionally, or alternatively, the control circuit may be configured to reduce the target bus voltage in the DC mode.

The load control device may comprise a controllable switching circuit electrically coupled in series with the bus capacitor. The control circuit may be configured to render the controllable switching circuit conductive in the AC mode and non-conductive in the DC mode. The control circuit may include a rectifier circuit that includes input terminals and a DC detect circuit. The rectifier circuit may also include a plurality (e.g., two) controllable switching circuits. The DC detect circuit may be electrically coupled between the input terminals of the rectifier circuit. The DC detect circuit may be configured to render the controllable switching circuits of the rectifier circuit conductive when the voltage across the DC detect circuit is a DC voltage (e.g., and render them non-conductive when the voltage across the DC detect circuit is AC voltage). The load control device may also include a ripple detect circuit (e.g., AC ripple detect circuit) that is configured to receive a rectified voltage and generate a ripple detect signal that indicates whether AC ripple is present in the rectified voltage. The ripple detect circuit may provide the ripple detect signal to the control circuit, and the control circuit may be configured to determine whether the input voltage is AC voltage or DC voltage based on the ripple detect signal.

The rectifier circuit may be configured to rectify the input voltage to generate a rectified voltage when the input voltage is an AC voltage, and to pass through the input voltage when the input voltage is a DC voltage. The rectifier circuit may comprise: (1) first and second input terminals (e.g., AC input terminals); (2) first and second output terminals (e.g., DC output terminals); (3) a first diode configured to conduct current from the first input terminal to the first output terminal; (4) a second diode configured to conduct current from the second output terminal to the second input terminal; (5) a third diode configured to conduct current from the second input terminal to the first output terminal; (6) a fourth diode configured to conduct current from the second output terminal to the first input terminal; (7) a first controllable switching circuit (e.g., a MOSFET) coupled in parallel with the first diode; and (8) a second controllable switching circuit (e.g., a MOSFET) coupled in parallel with the second diode. The first and second switching circuits may be rendered non-conductive when a voltage across the input terminals is an AC voltage and rendered conductive when the voltage across the input terminals is a DC voltage. The rectifier circuit may also comprise a DC detect circuit that may be electrically coupled between the input terminals and may be configured to render the first and second controllable switching circuits conductive when the voltage across the DC detect circuit is a DC voltage.

### BRIEF DESCRIPTION OF THE DRAWINGS

FIG. 1 is a simplified block diagram of an example light-emitting diode (LED) driver for controlling the intensity of an LED light source.

FIG. 2 is an example plot of a target bus voltage as a function of an amount of power required by an electrical load.

FIG. 3 is an example diagram of an AC ripple detect circuit for an LED driver.

FIG. 4 is a simplified schematic diagram of an example isolated, half-bridge forward converter and a current sense circuit of an LED driver.

FIG. 5 is a simplified schematic diagram of an example rectifier circuit.

FIG. 6 are example waveforms illustrating the operation of the rectifier circuit of FIG. 5.

FIG. 7 is an example diagram of a DC detect circuit for an LED driver.

FIG. 8 is a simplified flowchart of an example control procedure executed by a control circuit of a load control device (e.g., an LED driver).

### DETAILED DESCRIPTION

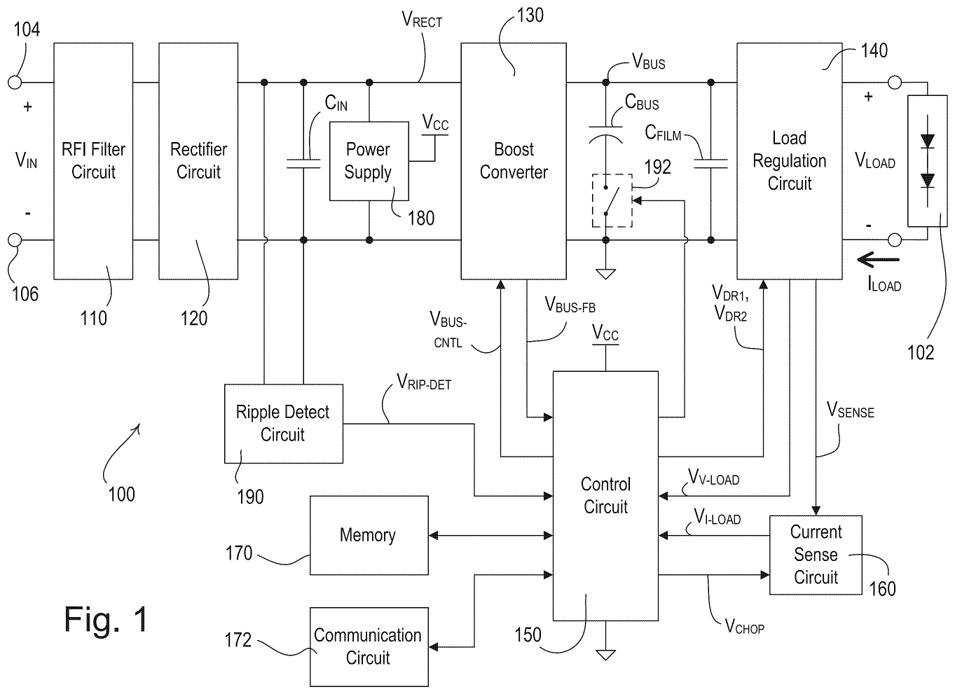

FIG. 1 is a simplified block diagram of a load control device, e.g., a light-emitting diode (LED) driver 100, for controlling the amount of power delivered to an electrical load, such as an LED light source 102 (e.g., an LED light engine), and thus the intensity of the electrical load. The LED light source 102 is shown as a plurality of LEDs connected in series, but may comprise a single LED, or a plurality of LEDs connected in parallel, or a suitable combination thereof, depending on the particular lighting system. The LED light source 102 may comprise one or more organic light-emitting diodes (OLEDs). The LED driver 100 may comprise a first input terminal 104 (e.g., a hot terminal) and a second input terminal 106 (e.g., a neutral terminal) that are adapted to be coupled to a power source (not shown), such as, e.g., an alternating-current (AC) power source, or a direct-current (DC) power source. The first and second input terminals 104, 106 may be configured to receive an input voltage V_{IN}, e.g., an AC mains input voltage, or a DC input voltage.

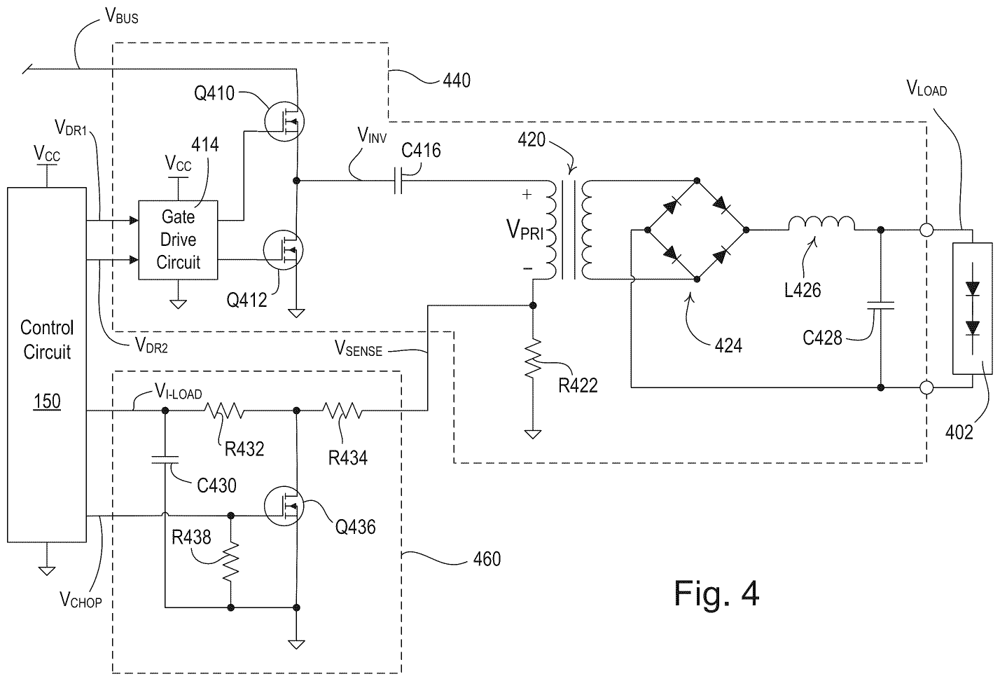

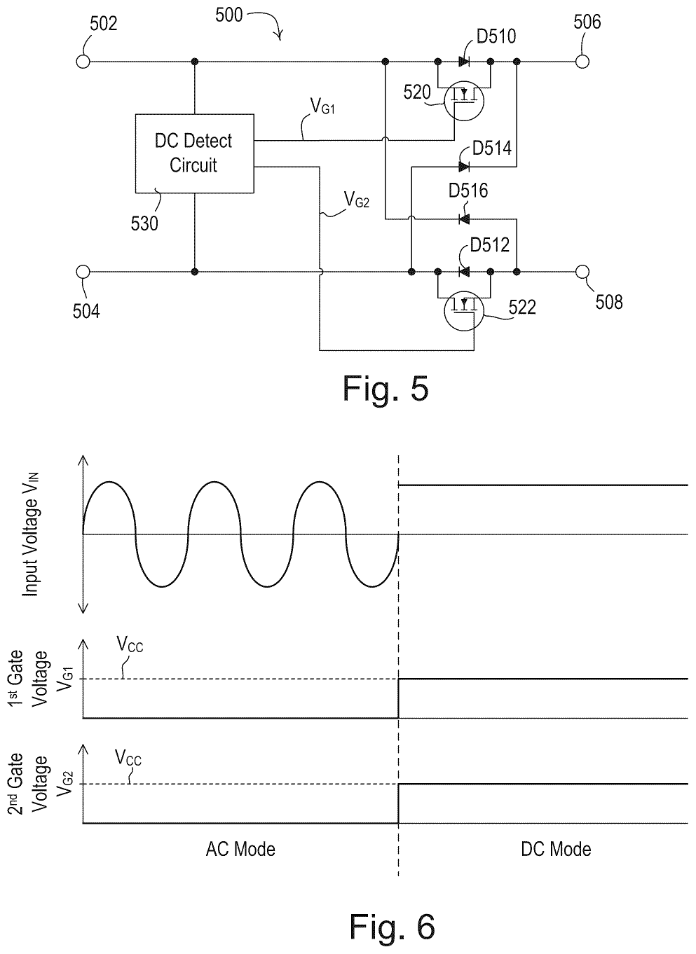

The LED driver 100 may comprise a radio-frequency (RFI) filter circuit 110, a rectifier circuit 120, a boost converter 130, a load regulation circuit 140, a control circuit 150, a current sense circuit 160, a memory 170, a communication circuit 172, and/or a power supply 180. The RFI filter circuit 110 may minimize the noise provided on the AC mains. The rectifier circuit 120 may be a dynamic rectifier circuit configured to change its operation in response to whether an AC voltage or a DC voltage is present at the input terminals 104, 106 (as will be described in greater detail below with reference to FIGS. 4 and 5). The rectifier circuit 120 may be configured to rectify the input voltage V_{IN} to generate a rectified voltage V_{RECT} when the input terminals are connected to an AC power source and an AC voltage is present at the input terminals 104, 106. The rectifier circuit 120 may be configured to pass through the input voltage V_{IN} (e.g., not rectify the input voltage V_{IN}) when the input terminals are connected to a DC power source and a DC voltage is present at the input terminals 104, 106.

The boost converter 130 may receive the rectified voltage V_{RECT} and generate a boosted direct-current (DC) bus voltage V_{BUS} across a bus capacitor C_{BUS} (such as, e.g., an electrolytic capacitor). The boost converter 130 may comprise any suitable power converter circuit for generating an appropriate bus voltage, such as, for example, a flyback converter, a single-ended primary-inductor converter (SEPIC), a Ćuk converter, or other suitable power converter circuit. The boost converter 130 may operate as a power factor correction (PFC) circuit to adjust the power factor of the LED driver 100 towards a power factor of one. The LED driver 100 may comprise an input capacitor C_{IN} (such as, e.g., a film capacitor) coupled across the input of the boost converter 130. Examples of LED drivers having boost converters are described in greater detail in commonly-assigned U.S. Pat. No. 8,492,987, issued Jul. 23, 2013, and U.S. Pat. No. 8,680,787, issued Mar. 25, 2014, both entitled LOAD CONTROL DEVICE FOR A LIGHT-EMITTING DIODE LIGHT SOURCE, the entire disclosures of which are hereby incorporated by reference.

The load regulation circuit 140 may receive the bus voltage V_{BUS} and control the amount of power delivered to the LED light source 102, for example, to control the intensity of the LED light source 102 between a low-end (i.e., minimum) intensity L_{LE} (e.g., approximately 1-5%) and a high-end (i.e., maximum) intensity L_{HE} (e.g., approximately 100%). An example of the load regulation circuit 140 may be an isolated, half-bridge forward converter. An example of the load control device (e.g., LED driver 100) comprising a forward converter is described in greater detail in commonly-assigned U.S. Pat. No. 9,253,829, issued Feb. 2, 2015, entitled LOAD CONTROL DEVICE FOR A LIGHT-EMITTING DIODE LIGHT SOURCE, the entire disclosure of which is hereby incorporated by reference. The load regulation circuit 140 may comprise, for example, a buck converter, a linear regulator, or any suitable LED drive circuit for adjusting the intensity of the LED light source 102.

The control circuit 150 may be configured to control the operation of the boost converter 130 and/or the load regulation circuit 140. The control circuit 150 may comprise, for example, a digital controller or any other suitable processing device, such as, for example, a microcontroller, a programmable logic device (PLD), a microprocessor, an application specific integrated circuit (ASIC), or a field-programmable gate array (FPGA). The control circuit 150 may generate a bus voltage control signal V_{BUS-CNTL}, which may be provided to the boost converter 130 for adjusting the magnitude of the bus voltage V_{BUS} towards a target bus voltage V_{BUS-TARGET}. The control circuit 150 may receive a bus voltage feedback control signal V_{BUS-FB} from the boost converter 130, which may indicate the magnitude of the bus voltage V_{BUS}.

The control circuit 150 may generate drive control signals V_{DR1}, V_{DR2}. The drive control signals V_{DR1}, V_{DR2} may be provided to the load regulation circuit 140 for adjusting the magnitude of a load voltage V_{LOAD} generated across the LED light source 102, and/or the magnitude of a load current I_{LOAD} conducted through the LED light source 120, for example, to control the intensity of the LED light source 120 to a target intensity L_{TRGT}. The control circuit 150 may adjust an operating frequency fop and/or a duty cycle DC_{INV} (e.g., an on-time T_{ON} as a percentage of the period T) of the drive control signals V_{DR1}, V_{DR2} to adjust the magnitude of the load voltage V_{LOAD} and/or the load current I_{LOAD}. The control circuit 150 may receive a load voltage feedback signal V_{V-LOAD} generated by the load regulation circuit 140. The load voltage feedback signal V_{V-LOAD} may indicate the magnitude of the load voltage V_{LOAD}.

The current sense circuit 160 may receive a sense voltage V_{SENSE} generated by the load regulation circuit 140. The sense voltage V_{SENSE} may indicate the magnitude of the load current I_{LOAD}. The current sense circuit 160 may receive a signal-chopper control signal V_{CHOP} from the control circuit 150. The current sense circuit 160 may generate a load current feedback signal V_{I-LOAD}, which may be a DC voltage indicating the average magnitude I_{AVE} of the load current I_{LOAD}. The control circuit 150 may receive the load current feedback signal V_{I-LOAD} from the current sense circuit 160 and control the drive control signals V_{DR1}, V_{DR2} accordingly. For example, the control circuit 150 may control the drive control signals V_{DR1}, V_{DR2} to adjust a magnitude of the load current I_{LOAD} to a target load current I_{TRGT} to thus control the intensity of the LED light source 102 to the target intensity L_{TRGT} (e.g., using a control loop). The control circuit 150 may be configured to determine a load power P_{LOAD} presently being consumed by the LED light source 102 using the load voltage feedback signal V_{V-LOAD} and the load current feedback signal V_{I-LOAD}. The load current I_{LOAD} may be the current that is conducted through the LED light source 120. The target load current I_{TRGT} may be the desired current that the control circuit 150 would ideally cause to be conducted through the LED light source 120 (e.g., based at least on the load current feedback signal V_{I-LOAD}).

The control circuit 150 may be coupled to the memory 170. The memory 170 may store operational characteristics of the LED driver 100 (such as, e.g., the target intensity L_{TRGT}, the low-end intensity L_{LE}, the high-end intensity L_{HE}, etc.). The communication circuit 172 may be coupled to, for example, a wired communication link, or a wireless communication link, such as a radio-frequency (RF) communication link or an infrared (IR) communication link. The control circuit 150 may be configured to update the target intensity L_{TRGT} of the LED light source 102 and/or the operational characteristics stored in the memory 170 in response to digital messages received via the communication circuit 172. The LED driver 100 may be operable to receive a phase-control signal from a dimmer switch for determining the target intensity L_{TRGT} for the LED light source 102. The power supply 180 may receive the rectified voltage V_{RECT} and generate a direct-current (DC) supply voltage V_{CC} for powering the circuitry of the LED driver 100.

The LED driver 100 may also comprise a ripple detect circuit 190, which may receive the rectified voltage V_{RECT} and may generate a ripple detect signal V_{RIP-DET} that may indicate whether AC ripple is present in the rectified voltage V_{RECT} (i.e., whether an AC voltage is coupled to the input terminals 104, 106). The control circuit 150 may receive the ripple detect signal V_{RIP-DET}, and may operate in an AC mode if an AC voltage is coupled to the input terminals 104, 106, or a DC mode if a DC voltage is coupled to the input terminals. The ripple detect circuit 190 may also be coupled to receive the input voltage V_{IN} and/or the bus voltage V_{BUS}. The LED driver 100 may also comprise a controllable switching circuit 192 (e.g., including a MOSFET) electrically coupled in series with the bus capacitor C_{BUS} for disconnecting the bus capacitor, as will be described in greater detail below.

When operating in the AC mode, the control circuit 150 may enable the operation of the boost converter 130 to generate the bus voltage V_{BUS} across the bus capacitor C_{BUS}. The control circuit 150 may render the controllable switching circuit 192 conductive and may control the magnitude of the bus voltage V_{BUS} to a maximum magnitude V_{BUS-MAX} (e.g., approximately 465 volts). The control circuit 150 may also operate the boost converter 130 as a PFC circuit during the AC mode to adjust the power factor of the LED driver 100 towards a power factor of one.

When operating in the DC mode, the control circuit 150 may be configured to disable the operation of the boost converter 130 to reduce power loss in the LED driver 100, for example, due to the power loss in the boost converter when enabled. When disabled, the boost converter 130 may pass through the DC voltage from the input terminals 104, 106, and the bus voltage V_{BUS} may have a minimum magnitude V_{BUS-MIN} (e.g., approximately 380 volts). When operating in the DC mode, the control circuit 150 may be configured to enable the boost converter 130 during a startup routine of the LED driver 100, and disable the boost converter during normal operation.

The control circuit 150 may render the controllable switching circuit 192 non-conductive to disconnect the bus capacitor C_{BUS} in the DC mode because the bus capacitor C_{BUS} may not be required when a DC voltage is present at the input terminals 104, 106. The LED driver 100 may also comprise a capacitor C_{FILM} (e.g., a film capacitor) coupled across the input of the load regulation circuit 140 for supplying high-frequency current that may be required to circulate through the load regulation circuit. Because the bus capacitor C_{BUS} may comprise one or more electrolytic capacitors, disconnecting the bus capacitor C_{BUS} may increase the lifetime of the LED driver 100. In addition, disconnecting the bus capacitor C_{BUS} may reduce an inrush current conducted by the LED driver 100 when power is first applied to the input terminals 104, 106.

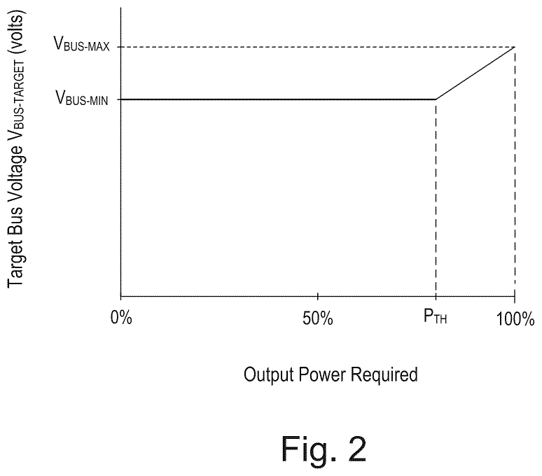

The control circuit 150 may also enable the operation of the boost converter 130 in the DC mode when the power P_{LOAD} required by LED light source 102 exceeds a threshold amount P_{TH} (e.g., approximately 80%). In addition, the control circuit 150 may also be configured to control the target bus voltage V_{BUS-TARGET} as a function of the power P_{LOAD} required by LED light source 102, for example, as shown in FIG. 2. The control circuit 150 may be configured to adjust the target bus voltage V_{BUS-TARGET} linearly between the minimum magnitude V_{BUS-MIN} and the maximum magnitude V_{BUS-MAX} when the power P_{LOAD} required by LED light source 102 is above the threshold amount P_{TH}. The control circuit 150 may be configured to control the target bus voltage V_{BUS-TARGET} using open loop control, for example, by using a lookup table to determine the target bus voltage V_{BUS-TARGET} in response to the target intensity L_{TRGT} and/or target load current I_{TRGT}. The control circuit 150 may also be configured to control the target bus voltage V_{BUS-TARGET} using closed loop control, for example, by using the load voltage feedback signal V_{V-LOAD} and the load current feedback signal V_{I-LOAD} to determine the power P_{LOAD} required by LED light source 102. The control circuit 150 may be configured to learn the target intensity L_{TRGT} and/or the target load current I_{TRGT} at which the power P_{LOAD} required by LED light source 102 exceeds the threshold amount P_{TH} (e.g., during a startup routine).

The control circuit 150 may be configured to temporarily increase the magnitude of the bus voltage V_{BUS} during transient events (e.g., when increasing and/or decreasing the target intensity L_{TRGT} and/or the target load current I_{TRGT}).

Rather than disabling the boost converter 130 in the DC mode, the control circuit 150 may also scale back the operation of the boost converter (e.g., reduce the target bus voltage V_{BUS-TARGET}) so as to reduce losses in the boost converter.

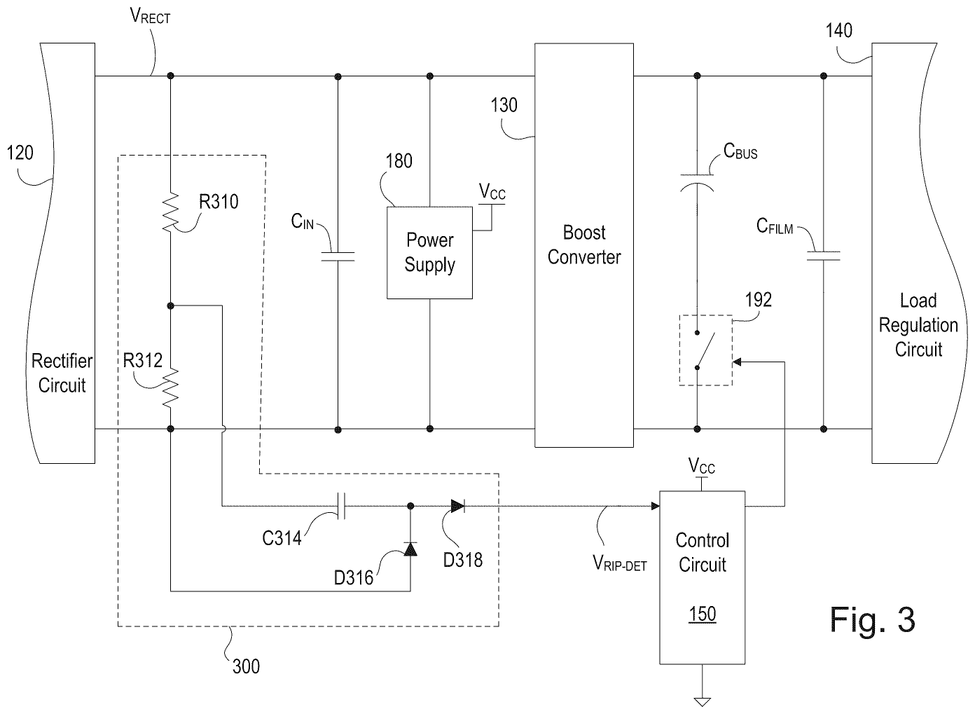

FIG. 3 is an example diagram of an AC ripple detect circuit 300 for an LED driver. The AC ripple detect circuit 300 may be an example of the AC ripple detect circuit 190 of the LED driver 100 shown in FIG. 1. The AC ripple detect circuit 300 may include resistors R310, R312, capacitor C314, and diodes D316, D318. The AC ripple detect circuit 300 may receive the rectified voltage V_{RECT} and may generate the ripple detect signal V_{RIP-DET}. The control circuit 150 may receive the ripple detect signal V_{RIP-DET} and may determine whether AC voltage or DC voltage is connected to the input terminals (e.g., the input terminals 104, 106). For example, the control circuit 150 may receive the ripple detect signal V_{RIP-DET} and determine whether AC ripple is present in the rectified voltage V_{RECT}.

If AC voltage is present at the input terminals 104, 106, a full-wave rectified voltage may be present at the resistor R310. The full-wave rectified voltage may be twice the normal line frequency. The full-wave rectified voltage may be divided via the resistors R310, R312, and the divided voltage may charge the capacitor C314 and be fed through the diode D318 to generate the ripple detect signal V_{RIP-DET}. If DC voltage is present at the input terminals 104, 106, the voltage present at the resistor R310 will not be characterized by a significant AC frequency component. As such, the capacitor C314 will not charge, resulting in the ripple detect signal V_{RIP-DET} having a lower value (e.g., 0 volts) than instances where AC voltage is present at the input terminals 104, 106. Accordingly, the control circuit 150 may receive the ripple detect signal V_{RIP-DET}, and may operate in an AC mode if an AC voltage is coupled to the input terminals 104, 106, or a DC mode if a DC voltage is coupled to the input terminals. The ripple detect circuit 300 may also be coupled to receive the input voltage V_{IN} and/or the bus voltage V_{BUS}.

FIG. 4 is a simplified schematic diagram of an isolated, half-bridge forward converter 440 and a current sense circuit 460 of an LED driver (e.g., the LED driver 100 shown in FIG. 1). The forward converter 440 may be an example of the load regulation circuit 140 of the LED driver 100 shown in FIG. 1. The current sense circuit 460 may be an example of the current sense circuit 160 of the LED driver 100 shown in FIG. 1.

The forward converter 440 may comprise a half-bridge inverter circuit having two field effect transistors (FETs) Q410, Q412 for generating a high-frequency inverter voltage V_{INV} from the bus voltage V_{BUS}. The FETs Q410, Q412 may be rendered conductive and non-conductive in response to the drive control signals V_{DR1}, V_{DR2}. The drive control signals V_{DR1}, V_{DR2} may be received from the control circuit 150. The drive control signals V_{DR1}, V_{DR2} may be coupled to the gates of the respective FETs Q410, Q412 via a gate drive circuit 414 (e.g., which may comprise part number L6382DTR, manufactured by ST Microelectronics). The control circuit 150 may generate the inverter voltage V_{INV} at a constant operating frequency f_{OP} (e.g., approximately 60-65 kHz) and thus a constant operating period T_{OP}. However, the operating frequency f_{OP} may be adjusted under certain operating conditions. For example, the operating frequency for may be decreased near the high-end intensity L_{HE}. The control circuit 150 may be configured to adjust a duty cycle DC_{INV} of the inverter voltage V_{INV} to control the intensity of an LED light source 402 towards the target intensity L_{TRGT}. The control circuit 150 may adjust the duty cycle DC_{INV} of the inverter voltage V_{INV} to adjust the magnitude (e.g., the average magnitude I_{AVE}) of the load current I_{LOAD} towards the target load current I_{TRGT}. The magnitude of the load current I_{LOAD} may vary between a maximum rated current I_{MAX} and a minimum rated current I_{MIN}.

The inverter voltage V_{INV} may be coupled to the primary winding of a transformer 420 through a DC-blocking capacitor C416 (e.g., which may have a capacitance of approximately 0.047 μF), such that a primary voltage V_{PRI} is generated across the primary winding. The transformer 420 may be characterized by a turns ratio n_{TURNS} (i.e., N₁/N₂), which may be approximately 115:29. A sense voltage V_{SENSE} may be generated across a sense resistor R422, which may be coupled in series with the primary winding of the transformer 420. The secondary winding of the transformer 420 may generate a secondary voltage that may be coupled to the input terminals of a full-wave diode rectifier bridge 424 for rectifying the secondary voltage generated across the secondary winding. The positive output terminal of the rectifier bridge 424 may be coupled to the LED light source 402 through an output energy-storage inductor L426 (e.g., which may have an inductance of approximately 10 mH), such that the load voltage V_{LOAD} may be generated across an output capacitor C428 (e.g., which may have a capacitance of approximately 3 μF).

The current sense circuit 460 may comprise an averaging circuit for producing the load current feedback signal V_{I-LOAD}. The averaging circuit may comprise a low-pass filter comprising a capacitor C430 (e.g., which may have a capacitance of approximately 0.066 μF) and a resistor R432 (e.g., which may have a resistance of approximately 3.32 k Ω. The low-pass filter may receive the sense voltage V_{SENSE} via a resistor R434 (e.g., which may have a resistance of approximately 1 kΩ. The current sense circuit 460 may comprise a transistor Q436 (e.g., a FET as shown in FIG. 4) coupled between the junction of the resistors R432, R434 and circuit common. The gate of the transistor Q436 may be coupled to circuit common through a resistor R438 (e.g., which may have a resistance of approximately 22 kΩ. The gate of the transistor Q436 may receive the signal-chopper control signal V_{CHOP} from the control circuit 150. An example of the current sense circuit 460 may be described in greater detail in commonly-assigned U.S. Pat. No. 9,232,574, issued Jan. 5, 2016, entitled FORWARD CONVERTER HAVING A PRIMARY-SIDE CURRENT SENSE CIRCUIT, the entire disclosure of which is hereby incorporated by reference.

FIG. 5 is a simplified schematic diagram of an example rectifier circuit 500 (e.g., the rectifier circuit 120 of the LED driver 100 shown in FIG. 1). The rectifier circuit 500 may comprise first and second input terminals 502, 504 (e.g., AC input terminals) and first and second output terminals 506, 508 (e.g., DC output terminals). The rectifier circuit 500 may comprise a full-wave rectifier including four diodes 510, 512, 514, 516. The first diode 510 may be electrically coupled between the first input terminal 502 and the first output terminal 506, and may be configured to conduct current from the first input terminal 502 to the first output terminal 506. The second diode 512 may be electrically coupled between the second input terminal 504 and the second output terminal 508, and may be configured to conduct current from the second output terminal 508 to the second input terminal 504. The third diode 514 may be electrically coupled between the second input terminal 504 and the first output terminal 506, and may be configured to conduct current from the second input terminal 504 to the first output terminal 506. The fourth diode 516 may be electrically coupled between the first input terminal 502 and the second output terminal 508, and may be configured to conduct current from the second output terminal 508 to the first input terminal 502.

The rectifier circuit 500 may comprise a first controllable switching circuit 520 (e.g., a MOSFET) having main terminals electrically coupled in parallel with the first diode 510, and a second controllable switching circuit 522 (e.g., a MOSFET) having main terminals electrically coupled in parallel with the second diode 512. The first and second diodes 510, 512 may be body diodes of the first and second controllable switching circuits 520, 522, respectively, or may be implemented as separate parts. The rectifier circuit 500 may be configured to operate in an AC mode when a voltage (e.g., an input voltage) across the input terminals 502, 504 is an AC voltage, and in a DC mode when the voltage across the input terminals is a DC voltage. The first and second switching circuits 520, 522 may be rendered non-conductive in the AC mode (e.g., when the voltage across the input terminals is an AC voltage), and rendered conductive in the DC mode (e.g., when the voltage across the input terminals is a DC voltage).

The rectifier circuit 500 may further comprise a rectifier control circuit, such as a DC detect circuit 530, coupled between the input terminals 502, 504 to receive the voltage across the input terminals. The DC detect circuit 530 may be configured to generate gate drive voltages V_{G1}, V_{G2} that may be coupled to gate terminals of the MOSFETs of the first and second controllable switching circuits 520, 522, respectively, for rendering the first and second controllable switching circuits conductive and non-conductive.

FIG. 6 illustrates example waveforms of the rectifier circuit 500 when the rectifier circuit is operating in the AC mode and in the DC mode. The DC detect circuit 530 may be configured to control the magnitudes of the first and second gate drive voltages V_{G1}, V_{G2} towards a circuit common (e.g., approximately zero volts) to render the first and second controllable switching circuits 520, 522 non-conductive in the AC mode when the input voltage (e.g., the voltage across the input terminals 502, 504) is an AC voltage. The DC detect circuit 530 may be configured to control the magnitudes of the first and second gate drive voltages V_{G1}, V_{G2} towards a supply voltage V_{CC} (e.g., as generated by the power supply 180 of the LED driver 100 in FIG. 1) to render the first and second controllable switching circuits 520, 522 conductive in the DC mode when the input voltage (e.g., the voltage across the terminals 502, 504) is a DC voltage.

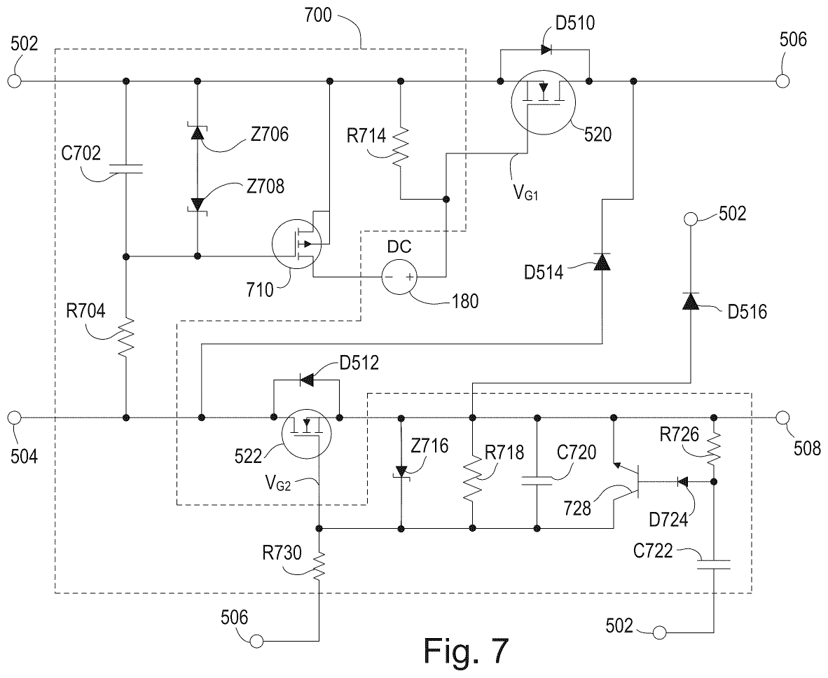

FIG. 7 is an example diagram of a DC detect circuit 700 for an LED driver. The DC detect circuit 700 may be an example of the DC detect circuit 530 of FIG. 5. As such, the DC detect circuit 700 may be part of a rectifier circuit, such as the rectifier circuit 500 shown in FIG. 5. The DC detect circuit 700 may include two input terminals, such as the first and second input terminals 502, 504 (e.g., AC input terminals) of the rectifier circuit 500. Further, the DC detect circuit may be connected to two output terminals through an AC/DC rectifier circuit, such as the first and second output terminals 506, 508 (e.g., DC output terminals) of the rectifier circuit 500. Accordingly, the DC detect circuit 700 may be configured to generate gate drive voltages for controlling controllable switching circuits, such as the gate drive voltages V_{G1}, V_{G2} that are coupled to gate terminals of the MOSFETs of the first and second controllable switching circuits 520, 522, respectively, for rendering the first and second controllable switching circuits conductive and non-conductive. In this regard, the DC detect circuit may operate whether it is coupled to an AC voltage or to a DC voltage via the input terminals 502, 504.

The DC detect circuit 700 may include capacitors C702, C720, and C722, resistors R704, R714, R718, R726, and R730, Zener diodes Z706, Z708, and Z716, a diode D724, a MOSFET 710, and an NPN transistor 728. The DC detect circuit 700 may include a power supply, or use a power supply of the LED drive, such as the power supply 180, for example.

When an AC voltage is coupled to the input terminals 502, 504, the combination of the capacitor C702 and resistor R704 will cause there to be a net zero DC voltage across the capacitor C702. As a result, the MOSFET 520 will be non-conductive and in diode mode across diode 510. Further, when an AC voltage is coupled to the input terminals 502, 504, the combination of the capacitor C722 and resistor R726 will cause there to be a net zero DC voltage across the capacitor C722. For example, the NPN transistor 728 may see pulsing currents at its gate, rendering the NPN transistor 728 conductive and causing the capacitor C720 to discharge. The discharge of the capacitor C720 may cause the MOSFET 522 to be rendered non-conductive and in diode mode across the diode 512. Accordingly, when an AC voltage is coupled to the input terminals 502, 504, the DC detect circuit will not drive either of the MOSFETs 520, 522 to be conductive such that the diodes 510, 512, 514, 516 act as a full-wave rectifier.

When a DC voltage is coupled to the input terminals 502, 504, the Zener diodes Z706, Z708 will clamp the input DC voltage and cause the capacitor C702 to charge. When the capacitor C702 is charged, the MOSFET 710 will turn on, which will drive the first gate drive voltage V_{G1} towards a supply voltage V_{CC} (e.g., as generated by the power supply 180 of the LED driver 100 in FIG. 1) and render the MOSFET 520 conductive. Further, when a DC voltage is coupled to the input terminals 502, 504, the capacitor C722 will charge and there will not be pulsing currents flowing through R726 (e.g., as is seen when AC voltage is coupled to the input terminals). As a result, the NPN transistor 728 will be rendered non-conductive, which will drive the second gate drive voltage V_{G2} towards the supply voltage V_{CC} and render the MOSFET 522 conductive. When the MOSFETs 520, 522 are conductive, the voltage losses across the diodes 510, 512 are eliminated.

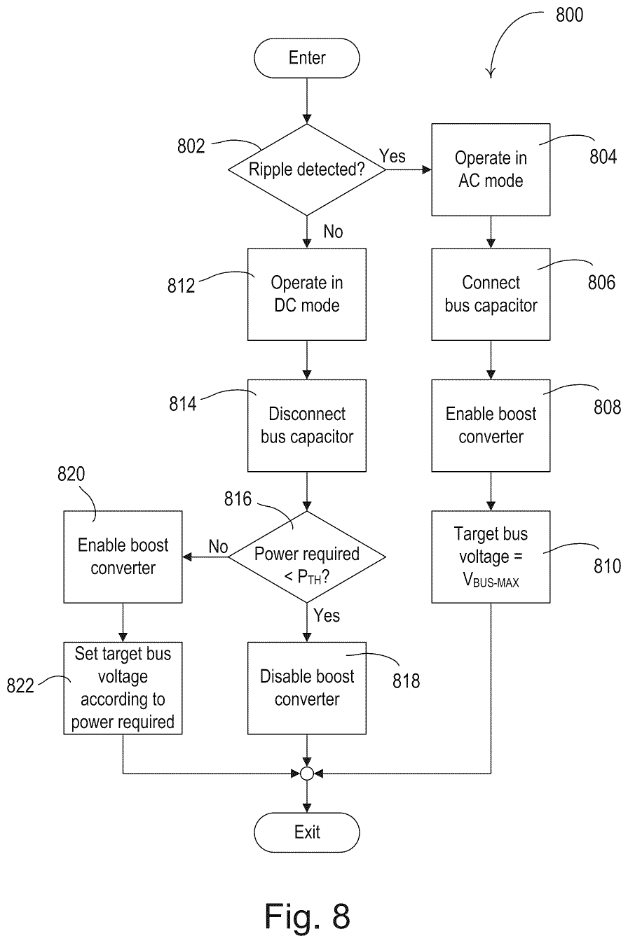

FIG. 8 is a simplified flowchart of an example control procedure 800 that may be executed by a control circuit of a load control device (e.g., the control circuit 150 of the LED driver 100). For example, the control procedure 800 may be executed periodically to control the LED driver to operate in an AC mode or a DC mode in response to ripple detected on an input voltage of the LED driver. At 802, the control circuit may determine whether the ripple detect signal V_{RIP-DET} indicates that AC voltage or DC voltage is coupled to the input terminals (e.g., the input terminals 104, 106). If the control circuit determines that AC voltage is coupled to the input terminals at 802, then the control circuit may operate in AC mode at 804. For example, the control circuit may ensure that the bus capacitor is connected at 806. For instance, the control circuit may connect the bus capacitor by closing a switch (e.g., the controllable switching circuit 192) at 806. The control circuit may also enable the boost converter at 808, and set the target bus voltage to V_{BUS-MAX} at 810.

If the control circuit determines that DC voltage is coupled to the input terminals at 802, then the control circuit may operate in DC mode at 812. For example, the control circuit may ensure that the bus capacitor is disconnected at 814. For instance, the control circuit may disconnect the bus capacitor by opening the switch (e.g., the controllable switching circuit 192) at 814. At 816, the control circuit may determine whether the power P_{LOAD} required by the electrical load exceeds a threshold amount P_{TH} (e.g., approximately 80%). If the control circuit determines that the power P_{LOAD} required by the electrical load does not exceed the threshold amount P_{TH} at 816, then the control circuit may disable the boost converter at 818. For example, the control circuit may disable the boost converter to reduce power loss in the LED driver, for example, due to the power loss in the boost converter when enabled. When disabled, the boost converter may pass through the DC voltage from the input terminals, and the bus voltage V_{BUS} may have a minimum magnitude V_{BUS-MIN} (e.g., approximately 380 volts). In some instances, when operating in the DC mode, the control circuit may be configured to enable the boost converter during a startup routine (not shown) of the LED driver, and disable the boost converter during normal operation.

If the control circuit determines that the power P_{LOAD} required by the electrical load does exceed the threshold amount P_{TH} at 816, then the control circuit may enable the boost converter at 820. At 822, the control circuit may set the target bus voltage according to the power required. For example, the control circuit may be configured to control the target bus voltage V_{BUS-TARGET} as a function of the power P_{LOAD} required by LED light source 102. The control circuit may be configured to adjust the target bus voltage V_{BUS-TARGET} linearly between the minimum magnitude V_{BUS-MIN} and the maximum magnitude V_{BUS-MAX} when the power P_{LOAD} required by LED light source is above the threshold amount P_{TH}. The control circuit may be configured to control the target bus voltage V_{BUS-TARGET} using open loop control, for example, by using a lookup table to determine the target bus voltage V_{BUS-TARGET} in response to the target intensity L_{TRGT} and/or target load current I_{TRGT}. The control circuit may be configured to control the target bus voltage V_{BUS-TARGET} using closed loop control, for example, by using the load voltage feedback signal V_{V-LOAD} and the load current feedback signal V_{I-LOAD} to determine the power P_{LOAD} required by LED light source. The control circuit may be configured to learn the target intensity L_{TRGT} and/or the target load current I_{TRGT} at which the power P_{LOAD} required by LED light source exceeds the threshold amount P_{TH} (e.g., during a startup routine).

Although described with reference to an LED driver, one or more embodiments described herein may be used with other load control devices. Also, a single control circuit may be coupled to, and/or adapted to, control multiple types of electrical loads in a load control system.

1. A light-emitting diode (LED) controller to accept either an alternating current (AC) supply voltage or a direct current (DC) supply voltage, comprising:
boost converter circuitry having input terminals conductively couplable to rectifier circuitry and output terminals couplable to a load regulation circuit;
a bus capacitor coupled across the output terminals of the boost converter circuitry;
LED driver control circuitry to:
determine whether a supply voltage to the rectifier circuitry is an alternating current (AC) voltage or a direct current (DC) voltage;
responsive to the determination that the supply voltage is a DC voltage:
cause switching circuitry to electrically disconnect a bus capacitor coupled in electrical parallel with the boost converter circuitry output;
determine a target power input to an operatively coupled electric load device; and
determine whether the target power input exceeds a defined power input threshold;
responsive to the determination that the target power input is above the defined power input threshold:
enable the boost converter circuitry; and
set a target voltage based on the determined target power input; or
responsive to the determination that the target power input is at or below the defined power input threshold:
disable the boost converter circuitry.

2. The LED controller of claim 1 wherein the LED driver control circuitry to further:
responsive to the determination that the supply voltage is an AC voltage:
cause the switching circuitry to electrically couple the bus capacitor in electrical parallel with the boost converter circuitry output;
generate an output signal to enable the boost converter circuitry; and
set a target voltage based on the determined target power input.

3. The LED controller of claim 1 wherein to determine whether the supply voltage to the inverter circuitry is an AC voltage or a DC voltage, the LED driver control circuitry to further:
receive an input signal from ripple detect circuitry coupled to an output of the rectifier circuitry.

4. The LED controller of claim 1 wherein responsive to the determination that the target power input is above the defined power input threshold, the LED driver control circuitry to further:
generate an output signal to adjust the boost converter output voltage as a function of the target power input to the electric load device.

5. The LED controller of claim 1 wherein to adjust the boost converter output voltage as a function of the target power input to the electric load device, the LED driver control circuitry to further:
generate an output signal to adjust the boost converter output voltage linearly between a bus voltage minimum value and a bus voltage maximum value.

6. A light-emitting diode (LED) light control method to accept either an alternating current (AC) supply voltage or a direct current (DC) supply voltage, the method comprising:
determining, by LED driver control circuitry, whether a supply voltage to the rectifier circuitry is an alternating current (AC) voltage or a direct current (DC) voltage;
responsive to the determination by the LED driver control circuitry, that the supply voltage is a DC voltage:
causing, by the LED driver control circuitry, operatively coupled switching circuitry to electrically disconnect a bus capacitor coupled in electrical parallel with the boost converter circuitry output;
determining, by the LED driver control circuitry, a target power input to an operatively coupled electric load device; and
determining, by the LED driver control circuitry, whether the target power input exceeds a defined power input threshold;
responsive to the determination by the LED driver control circuitry that the target power input is above the defined power input threshold:
enabling, by the LED driver control circuitry, the boost converter circuitry; and
setting, by the LED driver control circuitry, a target voltage based on the determined target power input; or
responsive to the determination, by the LED driver control circuitry, that the target power input is at or below the defined power input threshold:
disabling, by the LED driver control circuitry, the boost converter circuitry.

7. The method of claim 6, further comprising:
responsive to the determination by the LED driver control circuitry, that the supply voltage is an AC voltage:
causing, by the LED driver control circuitry, the switching circuitry to electrically couple the bus capacitor in electrical parallel with the boost converter circuitry output;
generating, by the LED driver control circuitry, an output signal to enable boost converter; and
setting, by the LED driver control circuitry, a target voltage based on the determined target power input.

8. The method of claim 6 wherein determining whether the supply voltage to the inverter circuitry is an AC voltage or a DC voltage further comprises:
receiving, by the LED driver control circuitry, an input signal from ripple detect circuitry coupled to an output of the rectifier circuitry.

9. The method of claim 6 wherein responsive to the determination by the LED driver control circuitry, that the target power input is above the defined power input threshold further comprises:
generating, by the LED driver control circuitry, an output signal to adjust the boost converter output voltage as a function of the target power input to the electric load device.

10. The method of claim 9 wherein adjusting the boost converter output voltage as a function of the target power input to the electric load device further comprises:
generating, by the LED driver control circuitry, an output signal to adjust the boost converter output voltage linearly between a bus voltage minimum value and a bus voltage maximum value.

11. A non-transitory, machine-readable, storage device that includes instructions that, when executed by light-emitting diode (LED) driver control circuitry, causes the LED driver control circuitry to:
determine whether a supply voltage to the rectifier circuitry is an alternating current (AC) voltage or a direct current (DC) voltage;
responsive to the determination by the LED driver control circuitry, that the supply voltage is a DC voltage:
cause operatively coupled switching circuitry to electrically disconnect a bus capacitor coupled in electrical parallel with the boost converter circuitry output;
determine a target power input to an operatively coupled electric load device; and
determine whether the target power input exceeds a defined power input threshold;
responsive to the determination by the LED driver control circuitry that the target power input is above the defined power input threshold:
enable the boost converter circuitry; and
set a target voltage based on the determined target power input; or
responsive to the determination, by the LED driver control circuitry, that the target power input is at or below the defined power input threshold:
disable the boost converter circuitry.

12. The non-transitory, machine-readable, storage device of claim 11 wherein the instructions, when executed by the LED driver control circuitry, further cause the LED driver control circuitry to:
responsive to the determination by the LED driver control circuitry, that the supply voltage is an AC voltage:
cause the switching circuitry to electrically couple the bus capacitor in electrical parallel with the boost converter circuitry output;
generate an output signal to enable boost converter; and
set a target voltage based on the determined target power input.

13. The non-transitory, machine-readable, storage device of claim 11 wherein the instructions that cause the LED driver control circuitry to determine whether the supply voltage to the inverter circuitry is an AC voltage or a DC voltage further cause the LED driver control circuitry to:
receive an input signal from ripple detect circuitry coupled to an output of the rectifier circuitry.

14. The non-transitory, machine-readable, storage device of claim 11 wherein the instructions, when executed by the LED driver control circuitry, further cause the LED driver control circuitry to, responsive to the determination by the LED control circuitry, that the target power input is above the defined power input threshold:
generate an output signal to adjust the boost converter output voltage as a function of the target power input to the electric load device.

15. The non-transitory, machine-readable, storage device of claim 14 wherein the instructions that cause the LED driver control circuitry to adjust the boost converter output voltage as a function of the target power input to the electric load device further cause the LED driver control circuitry to:
generate an output signal to adjust the boost converter output voltage linearly between a bus voltage minimum value and a bus voltage maximum value.
